(19) United States
(12) Patent Application Publication
(10) Pub. No.: US 2012/0285841 A1
(43) Pub. Date: Nov. 15, 2012

(54) METHOD AND APPARATUS FOR SAFE STORAGE OR DISPOSAL OF RAZORS

(76) Inventors: DENNIS NOONAN, Hillsboro, NH (US); Anne Nolan, Keene, NH (US)

(21) Appl. No.: 13/104,610

(22) Filed: May 10, 2011

(51) Int. Cl. A45D 27/24; B65B 29/00; B26B 21/40

(52) U.S. Cl. 206/204; 206/352; 53/397

(57) ABSTRACT

Razors may be safely stored or disposed of in a container having a hollow body with an opening at a first end and a closed bottom at an opposite end. A slot in a wall of the body may extend from the opening. The opening may be large enough to allow passage of a head of the razor and the slot maybe large enough to allow passage of a handle of the razor.

### BACKGROUND OF THE INVENTION

The present invention generally relates to a system for safely disposing of or storing a razor after use of the razor.

Disposable razors are used in many settings that may require careful and safe disposal after use. Such razors may be employed in medical settings such as hospitals or surgery centers. In a medical setting, a used razor may be classified as a used sharp device which has been in contact with a patient (sometimes referred to as a SHARP). Regulatory requirements may define particular safety measures that must be followed during disposal of SHARPS.

For example, a disposal container for a SHARP may be required to be configured so that a person can insert a SHARP into the container using only one hand. Additionally such a container may be required to prevent removal of the SHARP after its insertion in the container.

Disposable razors may also be used in households with small children. In this context, safety issues may arise in which a curious child may pick up a razor and cause personal injury.

As can be seen, there is a need for a container in which a razor may be safely stored or discarded.

### SUMMARY OF THE INVENTION

In one aspect of the present invention, a container for a razor may comprise a hollow body with an opening at a first end and a closed bottom at an opposite end; and a slot in a wall of the body extending from the opening, the opening being large enough to allow passage of a head of the razor and the slot being large enough to allow passage of a handle of the razor.

In another aspect of the present invention, a method for disposing of razors in a medical setting may comprise the steps of placing a container onto a work surface with an open end of the container facing upwardly; and placing a head of the razor into the container while holding a handle of the razor in a position to align with a slot in the container.

In still another aspect of the invention, a method for safely storing a razor may comprise the steps of placing a head of the razor into the container while holding a handle of the razor in a position to align with a slot in the container; and closing the container with a cap.

These and other features, aspects and advantages of the present invention will become better understood with reference to the following drawings, description and claims.

### BRIEF DESCRIPTION OF THE DRAWINGS

FIG. 1 is a perspective view of a razor container in accordance with an embodiment of the invention;

FIG. 2 is an elevation view of the container of FIG. 1;

FIG. 3, is a sectional view of the container of FIG. 1 taken along the lines 3-3;

FIG. 4 is an end view of the container of FIG. 1;

FIG. 5 is a partial perspective view of a razor container in accordance with another embodiment of the invention; and

FIG. 6 is a full perspective view of the container of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide safe disposal or storage containers for razors which may preclude personal contact with blades of the razors.

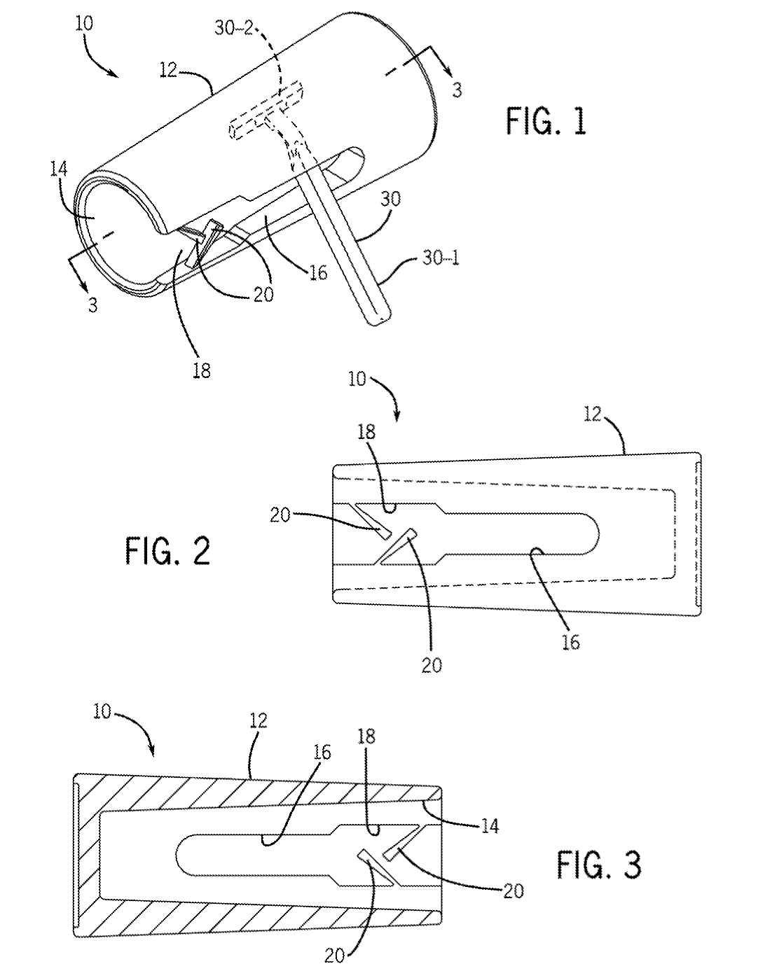

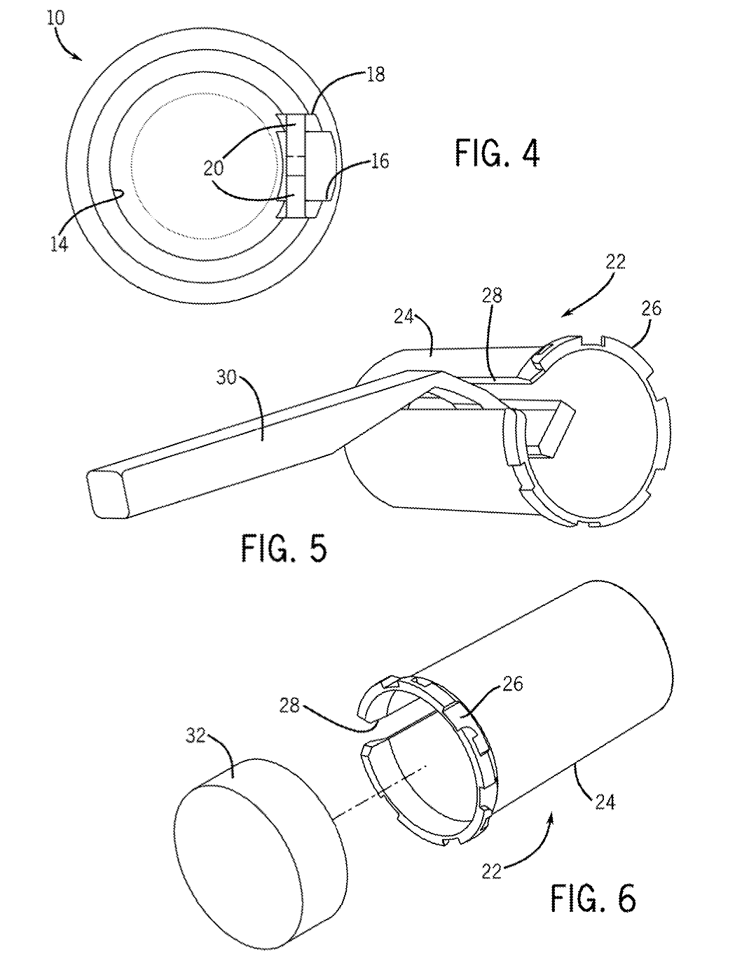

Referring now to FIGS. 1-4, an exemplary embodiment of a safety container 10 may be seen to comprise a cylindrical body 12, an opening 14, a small slot 16, a large slot 18 and stop gates 20. The container 10 may be particularly well suited for disposal of razors in a medical setting (e.g., SHARPS disposal in a hospital or surgical center).

In operation, the container 10 may be placed on a work surface, such as a bed-side table or desk, with the opening facing upwardly. The body 12 may have a frustro-conical shape so that a bottom 12-1 of the body 12 may provide a stable resting surface, thus facilitating one-handed operation. A user may put a razor 30 into the container 10 by holding a handle 30-1 of the razor and pushing a head 30-2 of the razor 30 into the opening 14. The handle 30-1 may initially project out of the slot 18. The handle 30-1 may displace the stop gates 20 as the razor 30 may be moved downwardly in the opening 14. The stop gates 20 may be molded integrally with the body 12 in a living-hinge configuration. As the handle 30-1 may be moved beyond the stop gates 20, the handle 30-1 may enter the small slot 16 in which the handle 30-1 may be securely retained. The stop gates 20 may prevent removal of the razor 30 from the container 10, thus assuring that the container 10 meets regulatory requirements relating to preclusion of removal.

Optionally, an absorbent pad 21 may be placed in the container 10 to absorb any fluids that may remain on the razor 30 after its use.

Referring now to FIGS. 5 and 6, an exemplary embodiment of a razor container 22 may be seen to comprise a cylindrical body 24, cap locking threads 26, a slot 28 and a cap 32. The container 22 may be particularly useful for storing one of the razors 30 in a setting in which small children may be at risk of picking up the razor and being injured. The head 30-2 of the razor 30 may be placed in the body with the handle 30-1 projecting out through the slot 28. After the head 30-1 is in the container 22, the cap 28 may be secured onto the body 24 with the cap locking threads 26. The cap 28 and the threads 26 may have a conventional child-proof configuration, similar to that used in medical prescription containers.

It should be understood, of course, that the foregoing relates to exemplary embodiments of the invention and that modifications may be made without departing from the spirit and scope of the invention as set forth in the following claims.

What is claimed is:

1. A container for a razor comprising:
a hollow body with an opening at a first end and a closed bottom at an opposite end; and
a slot in a wall of the body extending from the opening, the opening being large enough to allow passage of a head of the razor and the slot being large enough to allow passage of a handle of the razor.

2. The container of claim 1 wherein the body has a frustro-conical configuration.

3. The container of claim 1 further comprising stop gates positioned in the slot.

4. The container of claim 3 wherein the stop gates are molded integrally with the body in a living-hinge configuration.

5. The container of claim 1 further comprising an absorbent pad positioned within the container.

6. The container of claim 1 further comprising:
a cap; and
locking threads formed on the body adjacent the opening, the locking threads and the cap being configured to mate in a child-proof configuration.

7. A method for disposing of razors in a medical setting comprising the steps of:
placing a container onto a work surface with an open end of the container facing upwardly; and
placing a head of the razor into the container while holding a handle of the razor in a position to align with a slot in the container.

8. The method of claim 7 further comprising the step of pushing the handle beyond stop gates in the slot.

9. A method for safely storing a razor comprising the steps of:
placing a head of the razor into the container while holding a handle of the razor in a position to align with a slot in the container; and
closing the container with a cap.

10. The method of claim 9 wherein the step of closing comprises engaging the cap with child-proof locking threads on the container.
